(19) United States
(12) Patent Application Publication
(10) Pub. No.: US 2011/0162523 A1
(43) Pub. Date: Jul. 7, 2011

(54) GAS CLEANING METHOD AND APPARATUS

(75) Inventors: Mario Fabbri, Comacchio (IT); Enrico Sonno, Ghezzano (IT)

(73) Assignee: RE.CO 2 S.R.L., Pisa (IT)

(21) Appl. No.: 13/056,319

(22) PCT Filed: Aug. 6, 2009
(86) PCT No.: PCT/EP09/05720

§ 371 Date: Mar. 3, 2011

(30) Foreign Application Priority Data
Aug. 6, 2008 (IT) PI2008A000072

(51) Int. Cl. B03C 3/34; B03C 3/00; B03C 3/36

(52) U.S. Cl. 95/73; 95/79; 95/78; 96/80; 96/60; 96/53

(57) ABSTRACT

A plasma method and apparatus for purifying an offgas containing inorganic and organic pollutants. A plasma torch (26) is formed by interaction of the offgas (6) with an electric field (E) created by a voltage (V) applied between one or more couples of electrodes (16) arranged upstream/along a purification chamber (1); the electric field is such that an electric discharge takes place which ionizes the offgas (6) and causes a redistribution of atoms/molecules, thus creating longer molecules, which form a liquid residue (23), and shorter molecules, which form a purified gas (7). The gas undergoes an expansion that is caused by a diverging portion (21) of the purification chamber and assists preliminary cooling of the of fgas/purified gas (6/7). A tube-bundle exchanger (2) is provided and has a cross section larger than the outlet port (14) of the chamber to allow further expansion/cooling. A scrubber (3) is arranged downstream exchanger (2).

### FIELD OF THE INVENTION

The present invention relates to a method and an apparatus for purifying an offgas that contains various pollutants.

For instance, the method and the apparatus are well suited for treating offgas produced by industrial waste incineration units, where offgas is treated which contains both inorganic and organic pollutants, in particular, particulate matter and heavy metals.

### BACKGROUND OF THE INVENTION

Many human activities produce offgas, which may contain organic and inorganic pollutants to be eliminated before releasing the offgas into atmosphere.

Organic pollutants are normally destroyed by incineration, whose main limits are a large fuel consumption and the presence of residual, partially oxidized products in the exhaust gas, the combustion temperature being chosen as a compromise between the two problems. Another drawback of is the long transient that is needed to attain a full regime operation of conventional incineration equipment, and the low flexibility in case of variable feed throughput and/or quality, which in turn may be a cause of partial oxidation and toxic exhaust release.

Particulate solids, in particular inorganic particulate solids like ash, heavy metals, and the like, are often present in municipal waste incineration plants offgas; they are normally retained by selective filters, electro filters as well as deashing systems, which increase investment, operation and plant maintenance costs.

To cope with these problems, systems have been proposed, where the offgas, or even a liquid waste, is treated at a very high temperature and/or by a high electric field, to be converted into a plasma and a residual liquid, which result from a molecular rearrangement that occurs at such process conditions. Such systems are described, for instance, in US2003209174 and in WO2006021945.

In US2003209174 an oxidizing chamber is provided for treating an offgas produced by a chemical or by an incineration process, or by a waste plasma conversion treatment. The oxidizing chamber is heated by a burner that is obtained by ionizing a working gas in a DC powered plasma torch. The burner heating flow heats the chamber while in the chamber oxidizing agents, such as oxygen/steam are added in order to form an oxidizing environment. The offgas is then added such that it is purified by exposition to the hot oxidizing environment. The use of an oxygen-containing working gas enriches the oxidizing environment but it may cause instability, and a purification process may therefore result which is difficult to keep in control.

Furthermore, the treatment chamber of the offgas is cylindrical with a narrow outlet duct at the end of the chamber. In these conditions, a stationary and safe operation is difficult to attain.

WO2006021945 relates instead to pyrolisis/reaction chamber for waste liquids. The fluid chemical waste is pumped (140) into the chamber through an atomizer (160) such that a jet of small droplets of liquid waste contacts a plasma stream created by a plasma torch (220) that is arranged opposite to the atomizer. When the droplets contact the plasma stream the molecules of the waste from which the droplets are composed are dissociated into atoms and/or ions, recombine to form a mixture of product gases which exits the chamber and enter a post-pyrolysis subsystem, to neutralize further the mixture of product gases.

In both documents, the plasma torch is used as a burner, and so requires a feeding, of a working gas, thus requiring specific equipment for producing, pre- and post-treating, and possibly recycling the working gas prior to feeding it to the plasma torch, thus complicating the purification chamber and increasing investment, operation and maintenance costs.

### SUMMARY OF THE INVENTION

It is therefore an object of the present invention to provide a plasma method for purifying an offgas that contains organic and/or such inolganic pollutants as particulate matter, ash, heavy, which allows stable and safe operation.

It is another object of the present invention to provide such a method for purifying an offgas which require simple and short start-up procedures and is more flexible and safe with respect to sudden/frequent offgas feed rate changes with respect to prior art equipment.

Such method is carried out by an apparatus, to provide which is a further object of the present invention.

These and other objects are achieved by a method for purifying an offgas, comprising the steps of:

prearranging a purification chamber, the chamber having an inlet port to and an outlet port;

arranging a pair of electrodes in the purification chamber;

applying a voltage (V) to the electrodes such that an electric field (E) of prefixed intensity is established between the electrodes;

feeding the offgas to the purification chamber through the inlet port;

in the purification chamber turning the offgas into a ionized gas, i.e. a plasma, and

causing the ionized gas to separate into heavier molecules, which fall as a substantially liquid residue, i.e. a lava, and lighter molecules which form to a purified gas; collecting the purified gas from the purification chamber through the outlet port;

collecting the substantially liquid residue from the purification chamber. The main feature of the method is that the step of turning the offgas into a ionized gas is obtained by causing in the purification chamber an electrical discharge to pass between the electrodes through the offgas.

This way, there is not the need of a plasma torch for turning the offgas into a ionized gas, since the offgas same is turned directly into ionized gas by the electrical discharge that is formed between the electrodes.

Advantageously, the electrodes are arranged in such a way that the ionized gas same forms a ionized gas flow that is directed towards the outlet port.

Advantageously, said step of causing said ionized gas to separate is achieved by causing said plasma to expand while flowing through said purification chamber towards said outlet port.

Preferably, the expansion is caused by a progressive cross sectional enlargement of the purification chamber towards the outlet port.

The expansion and possibly the further expansion causes at the same time a gas temperature decrease and a gas speed decrease, in such a way that the residence time of purified gas at high temperature globally decreases. This is useful to avoid a recombination of the atoms present in the purified gas such to produce harmful compounds like dioxins and furans.

The temperature decrease also promotes a stable operation of the unit. Besides, the gas speed caused by the expansion in the purification chamber promotes gravity separation of possible liquid or solid residual from the plasma/gas stream.

Advantageously, a further expansion of said purified gas is caused by a cross sectional enlargement of an inlet portion of a cooling part of a heat exchanger.

In particular said cooling part has an enlarged cross sectional area set between three times and seven times said outlet port, more in particular said enlarged cross sectional area is about five times said a restricted cross sectional area of said outlet port (14). Preferably, the offgas hits an internal surface of the purification chamber proximate to the electrodes, in such a way that the offgas enters the chamber according to an inlet direction and undergoes a sudden change according to a predetermined diverted direction. In this way, the formation of the plasma from the offgas is enhanced.

In particular, the diverted direction is transversal to the inlet direction.

A further step can be provided of preheating the offgas prior to the step of feeding the offgas to the purification chamber.

In particular, further steps are provided of:

arranging a further pair of electrodes in the purification chamber downstream of the first pair of electrodes according to the gas flow;

applying a further voltage to the further electrodes such that a further electric field of prefixed intensity is established between the further electrodes for maintaining the plasma flow.

In particular, a step is provided of arranging more than one further pair of electrodes downstream of each other according to said gas flow.

In particular, the or any further pair of electrodes is arranged at a respective angle with respect to the pair of electrodes that is located immediately upstream of it. The presence of more than one pairs of electrodes enhances the flexibility of the method in case of frequent and/or sudden load changes, i.e. in case of frequent/sudden flow rate changes and/or offgas composition changes.

The offgas can contain both organic and inorganic pollutants, in particular, it can contain particulate solid and/or heavy metals. For example, it can be:

a power station offgas, like a gas turbine or an engine offgas;

an incinerator offgas;

an industrial process offgas;

a wastewater treatment offgas.

Advantageously, steps are provided of cooling and/or washing the purified gas; in particular, the cooling step can be carried out by heat exchange with a cooling fluid that allows recovering thermal energy from the offgas is treatment process; the recovered heat can be used in the preheating step of the new offgas that is fed to the process.

Said voltage (V) and/or said further voltage (V′) is preferably set between 5000 and 30000 Volt, most preferably between 10000 and 20000 Volt.

A method according to claim 1, wherein said pair of electrodes transfers by said discharge to said offgas an energy comprised between 0.5-1 KWh for each kg of impurities of said offgas, preferably said energy comprised between 0.7-0.9 KWh/kg of impurities.

The above-mentioned objects, and other objects, are also achieved by an apparatus for purifying an offgas, in particular for purifying an exhaust gas, the apparatus comprising:

a purification chamber, the chamber having an inlet port and an outlet port, the inlet port and the outlet port having respective prefixed cross sectional areas (R,S);

a pair of electrodes that are located inside the purification chamber;

a voltage applying means for applying to the electrodes a voltage such that an electric field of prefixed intensity is established between the electrodes;

an offgas feeding means for feeding the offgas into the purification chamber through the inlet port;

a means for turning the offgas into a ionized gas in the purification chamber, i.e. a plasma,

a means for causing the ionized gas to separate into heavier molecules, which fall as a substantially liquid residue, i.e. a lava, and lighter molecules which form a purified gas;

a gas collecting means for collecting the gas from the purification chamber;

a lava collecting/extracting means for collecting and extracting the lava from the purification chamber;

the main feature of the apparatus is that the means for turning the offgas into a ionized gas are adapted to cause an electrical discharge to pass through the offgas between said electrodes.

Preferably, said purification chamber has a progressively diverging portion, which is adapted to promote an expansion of the plasma that flows towards the outlet port.

In particular, the progressively diverging portion is located immediately downstream of the electrodes, and may extend along the whole purification chamber. As already stated, this feature increases purified gas residence time at high temperatures, which prevents harmful compounds to be formed by prolonged gas exposition to high temperatures.

In particular, the progressively diverging portion is a frusto-conical portion.

Preferably, the opening angle of the progressively diverging portion is set between two degrees and six degrees, most preferably the opening angle is about four degrees.

Preferably, the inlet port is oriented with respect to an inner surface in such a way that the offgas, after crossing the inlet port, hits the inner surface, and undergo therefore a sudden deviation that assists the offgas being changed into a plasma. In particular, the inlet port receives the offgas from an inlet duct tha has an axis substantially transverse to the axis of the purification chamber.

In particular, the pair of electrodes is a first pair of electrodes, and the purification chamber comprises:

a further pair of further electrodes;

a further voltage applying means for applying a further voltage to the further electrodes of the further pair of electrodes, such that a further electric field is established suitable for maintaining the plasma flow.

Advantageously, a heat exchanger for cooling the purified gas and/or a scrubber for washing the purified gas are arranged downstream of the outlet port of the purification chamber, the scrubber, if any, being arranged downstream of the heat exchanger.

In alternative, the apparatus may comprise an equipment that is a combination of a cooling and of a washing device.

The heat exchanger may have an inlet part upstream of its cooling part, ad an outlet part downstream of the cooling part. Advantageously, the cross sectional area of the heat exchanger increases according to the flow of the purified gas, such that the purified gas further expands before or inside the cooling part, and the cooling of the gas is promoted and/or enhanced.

Most preferably, the inlet part of the heat exchanges is a divergent inlet part for assisting a further expansion and therefore a further cooling of the gas even before the gas engages the true cooling part of the heat exchanger. In particular, the cooling part has an enlarged cross sectional area at a prefixed cross section, in particular at an upstream cross section, that ranges from three times to seven times the outlet port of the purification chamber, preferably such cooling cross sectional area is five times a restricted cross sectional area of the outlet port of the purification chamber.

Preferably, the heat exchanger has an inlet part suitable for assisting a further expansion of the purified gas, the heat exchanger having a cooling part with a cross sectional area ranging from three times to seven times the cross sectional area of the outlet port, preferably about five times the cross sectional area of the outlet port.

Advantageously, the exchanger comprises a tube-bundle, which in turn comprises tubes adapted to let the purified gas to flow and be cooled inside within the tubes.

Advantageously, the exchanger comprises a distributing duct that has holes for spraying a cooling liquid on a surface of said cooling part opposite to said purified gas, in particular, on an external surface of said tubes of said tube-bundle.

Preferably, the scrubber has a scrubbing chamber and a plurality of coils arranged therein, in particular substantially helix-shaped coils, the plurality preferably comprising a network of coils, the coils having holes for spraying or nebulising a scrubbing water uniformly distributed in the scrubbing chamber.

Preferably, the apparatus comprises a blower that creates a depression in the purification chamber; the residual pressure is preferably set between 5 and 10 absolute millibar.

### BRIEF DESCRIPTION OF THE DRAWINGS

The invention will now be made clearer with the following description of an embodiment thereof, exemplifying but not limitative, with reference to the attached drawings wherein:

FIG. 1 is a flow chart that shows the steps of the method according to the invention;

FIG. 2 is a cross sectional view of an apparatus according to an exemplary embodiment of the invention;

FIG. 3 is another cross sectional view of the apparatus of FIG. 2, taken at the outlet of the purification chamber;

FIG. 4 is a further cross sectional view of the apparatus of FIG. 2 that shows a surface heat exchanger included in the apparatus of FIG. 2;

FIG. 5 is a cross sectional view of an apparatus according to an alternate exemplary embodiment of the invention;

FIG. 6 is a diagram that shows typical temperatures along the apparatus of FIG. 2;

FIG. 7 is a cross sectional view of an apparatus according to another exemplary embodiment of the invention, in which two couples of electrodes are provided in the purification chamber;

FIG. 8 shows an exemplary embodiment of the tube-bundle of the apparatus according to the invention;

FIG. 9 shows an perspective view of an apparatus according to a further exemplary embodiment of the invention.

### DESCRIPTION OF PREFERRED EXEMPLARY EMBODIMENTS

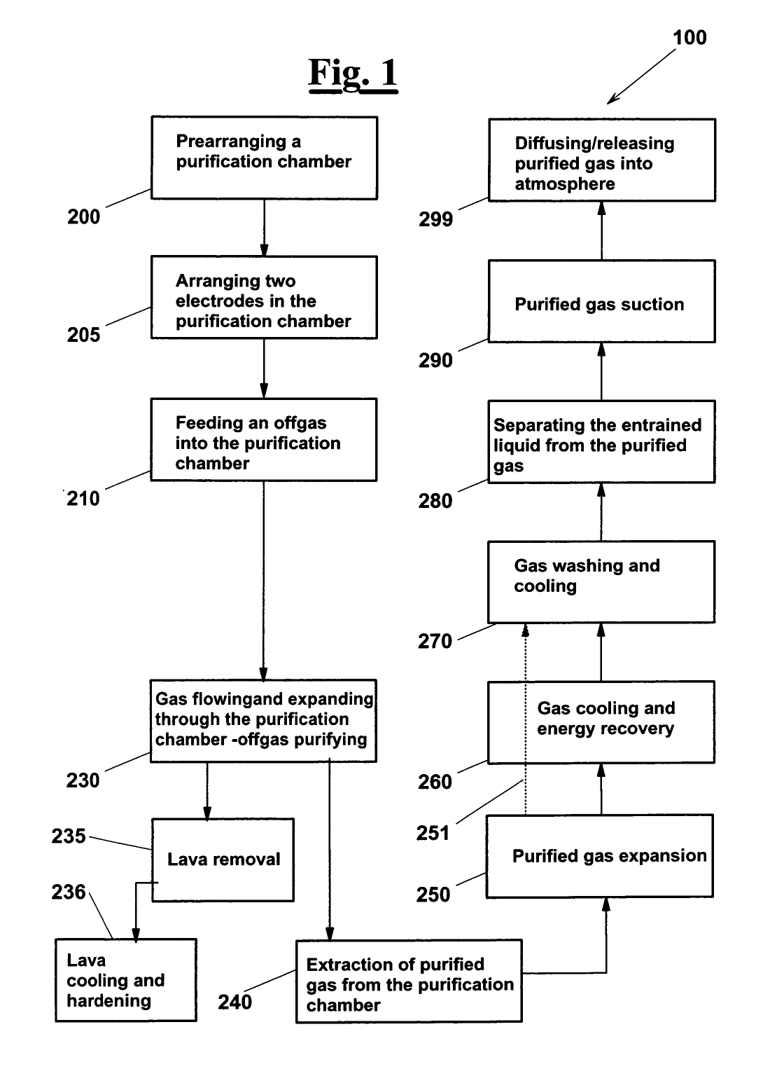

FIG. 1 shows diagrammatically the method according to the invention, where a step 200 is provided of prearranging a purification chamber 1 (FIG. 6) for treating an offgas 6, and a step 205 of arranging a couple of electrodes 16 in the purification chamber 1, that are connected to a voltage applying means 19. The method provides a step 210 of feeding offgas 6, which flows between electrodes 19 to form a plasma torch 26. Starting from electrodes 16, offgas 6 flows and expands through purification chamber 1 and undergoes a purifying step 230. During step 230, molecular changes take place such that offgas 6 is transformed into:

a purified gas 7, which consists substantially of oxidation products of the compounds organic that are present in offgas 6, in particular CO₂ and steam, possibly together with atmospheric nitrogen and minor amounts of not oxidized or of partially oxidized organic compounds;

a substantially liquid residue or a lava 23, which is collected and drained in a lava removing step 235 and then hardened by a preferably natural cooling step 236 to give a glassy material. By hardening step 236, lava 23 incorporates and fix such pollutants as heavy metals, which are therefore reduced to a is harmless state.

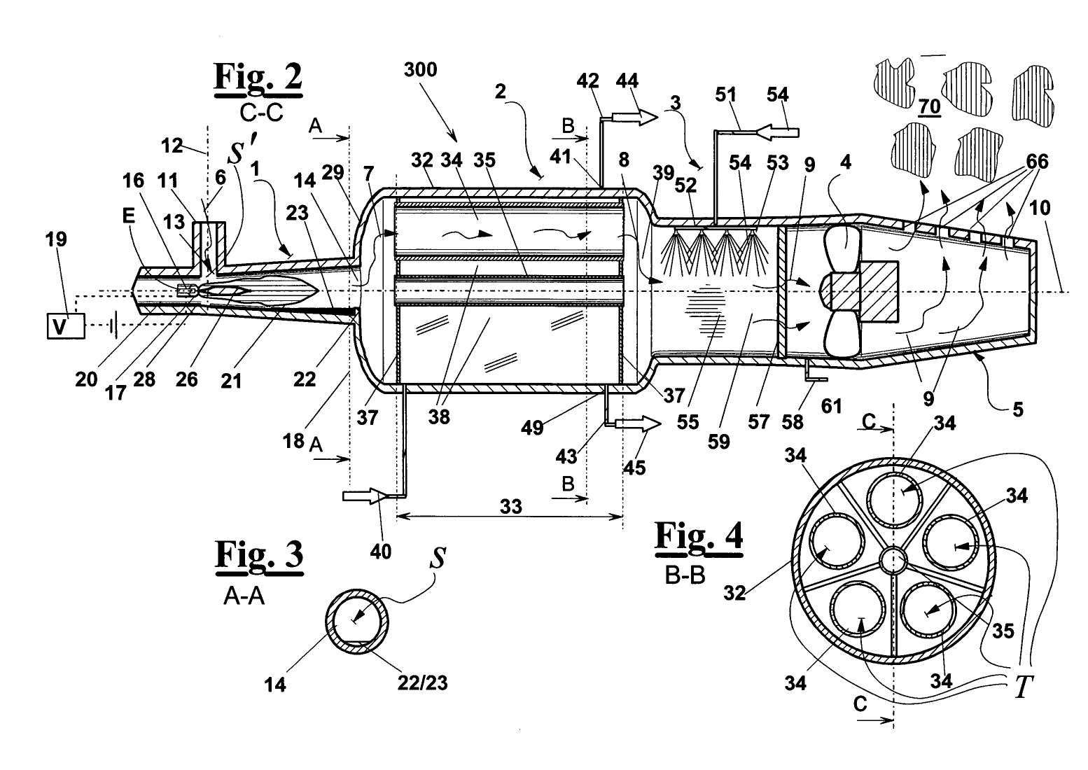

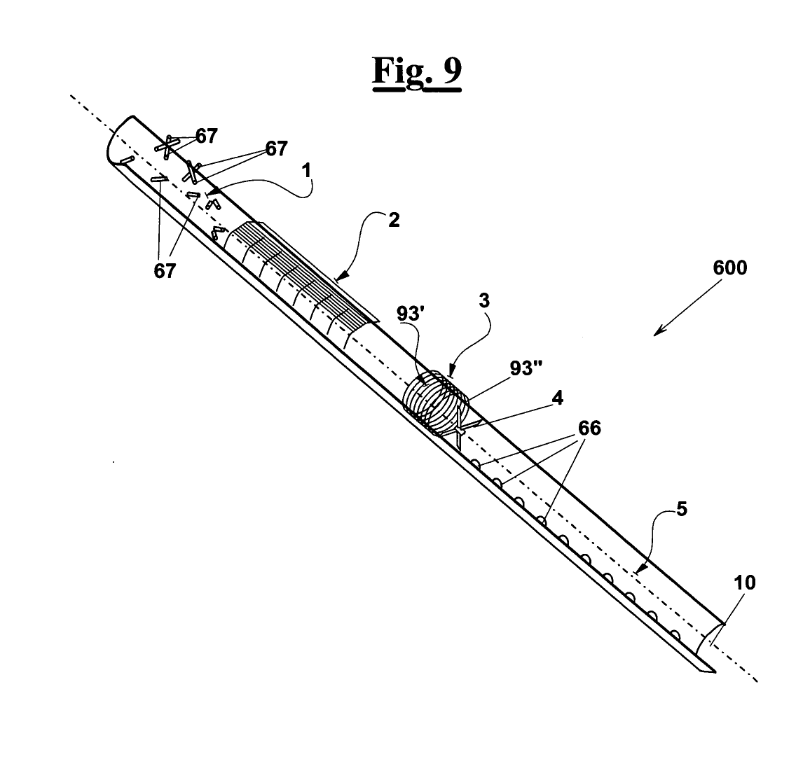

During the offgas purificating step 230, and after extraction 240 of purified gas 7 from purification chamber 1, offgas 6/purified gas 7 expands (steps 230 and 300), which assists an overall gas cooling ranging from about 1600° C. to about 100° C. Steps 230 and 240, as well as subsequent steps 260, 270 in which a further gas cooling takes place, are represented also in FIG. 6, which shows gas temperature changes throughout apparatus 300. Cooling step 260 takes place in a heat exchanger 2 (FIGS. 2 and 9), which allows a heat recovery, whereas step 270 is performed in a washing apparate, i.e. a scrubber 3, where an energy recovery is still possible responsive to the gas temperature after cooling 260: cooling water 54 partially vaporize by contacting cooled but still hot gas 8. In other words, also washing apparatus 3 can be used as a steam generator. Ultimate gas temperature must be below 100-150° C., to comply with local rules for gas emission into atmosphere. As indicated by dotted line 251, surface cooling step 260 is facultative, and overall cooling 73/74 (FIG. 6) can be carried out in a washing equipment, like in the case of apparatus 400 of FIG. 5. In any case, washed gas 8 carries a large amount of water, normally in the form of droplets, for which a step 280 of entrained liquid separation is provided before the step of suction 290 by a fan 4 and a step 299 of diffusion/releasing into atmosphere.

With reference to FIGS. 2, 3 and 4, an apparatus 300 is shown, for purifying an offgas 6, according to the method 100. Apparatus 300 comprises five consecutive stages that are arranged along an axis 10:

a purification chamber 1;

a tube-bundle exchanger 2;

a scrubber 3;

a fan or a blower 4;

a diffuser 5.

Purification chamber 1 extends between an offgas inlet port 13 and a purified gas outlet port 14; inlet port 13 is located at one end of a feeding nozzle 11. In purification chamber 1 a pair of electrodes 16 are arranged such that offgas 6 is forced to pass between them. Electrodes 16 are each connected to a voltage applying means 19 that applies a voltage V between them.

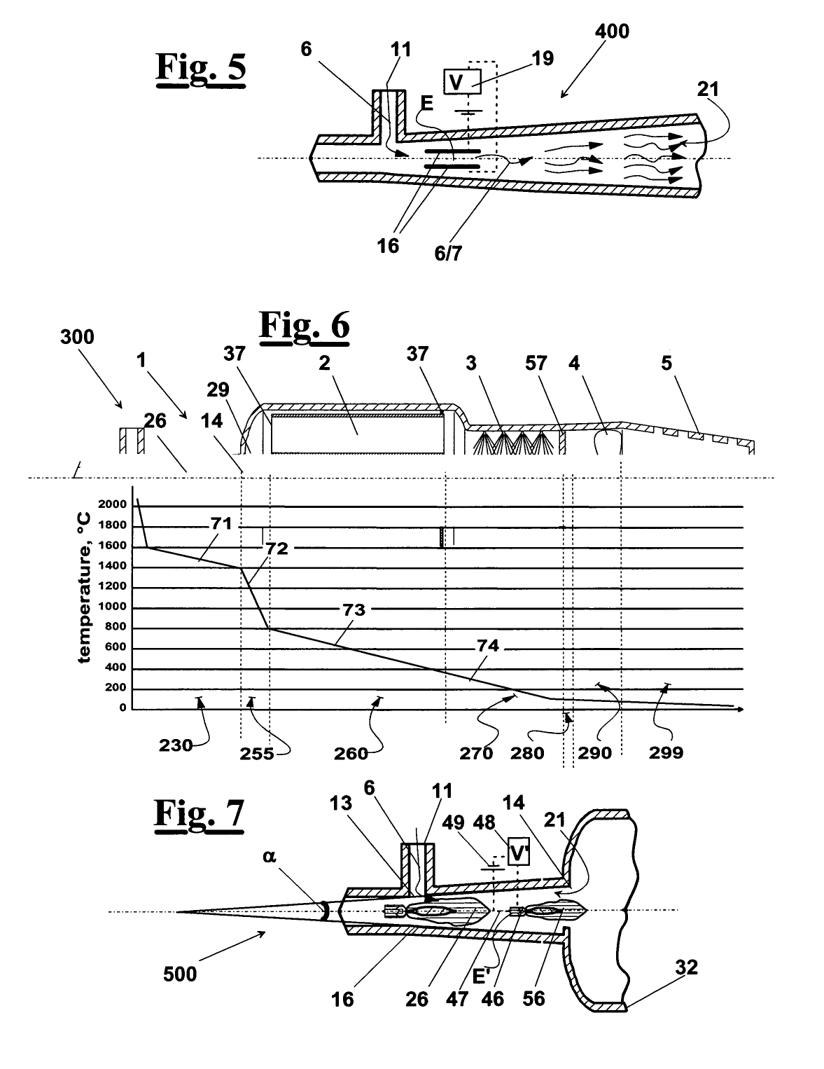

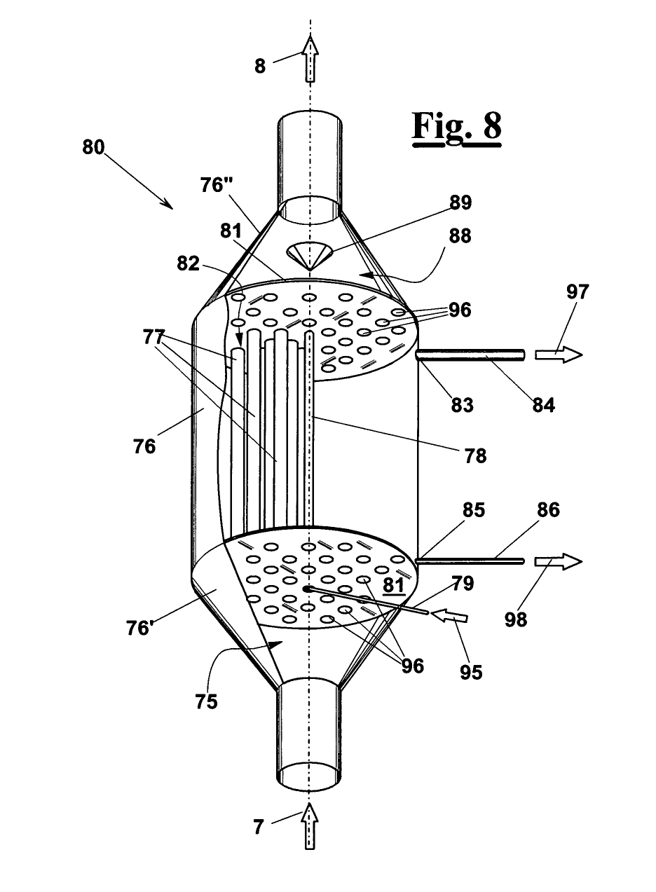

Purification chamber 1 has a progressively diverging portion 21, which in this embodiment is arranged immediately downstream of a cylindrical portion 20 where the electrodes are housed. In other words, the progressively diverging portion extends from a narrower cross section (17), which is located at a front side of said electrodes (16), to a larger cross section (18), that substantially corresponds to the cross section of outlet port (14). As a preferred embodiment, progressively diverging portion 21 is frusto-conical, and has an opening angle α (FIG. 7) that should be set between 2° and 6°, most preferably angle α is about 4°. Preferably, the transverse sections of portions 20 and 21 are circular. In particular, outlet port 14 (FIG. 3) has an edge 22 to allow the formation of a head 23 of liquid that is collected throughout purification chamber 1. Such head can be drained through a draining means, not shown.

Voltage V is adapted to create between electrodes 16 an electric field E such that an offgas is ionized, i.e. changed into a plasma, i.e. a plasma torch 26 is established in purification chamber 1, which is directed towards outlet port 14, according to gas flow. A current in the form of electric discharge is generates between electrodes 16, responsive to offgas pollutants content.

Conventional preheating means, not shown, can also be provided to preheat offgas 6 before or while it is fed to purification chamber 1, up to a temperature that assists plasma formation between electrodes 16.

Inlet nozzle 11 is preferably substantially transverse to axis 10 of purification chamber 1, such that offgas 6 hits an internal surface 28, in particular an inner side of a wall of purification chamber 1, and undergoes a sudden deviation to the direction of axis 10. This assists triggering and maintaining plasma torch 26. The same result can be obtained by arranging within purification chamber 1 a deflecting surface.

In particular, offgas 6 organic compounds are converted into carbon bioxide and water, that accompany nitrogen, or another inert gas possibly contained in offgas 6. Offgas 6 may also contain particulate solids that are changed into an inert lava that accumulates in a lower part of diverging portion 21, creating head 23 contained by an edge 22. As anticipated, the lava is drained from purification chamber 1, and is cooled to give a glassy material that embeds offgas 6 metal pollutants, in particular, heavy metals.

FIG. 5 shows a cross sectional view of an apparatus 400 according to an alternate exemplary embodiment of the invention, in which electrodes 16 are arranged downstream of inlet nozzle 11, in such a way that offgas 6 flows through negative electrodes 16.

As shown in FIG. 6, offgas 6/purified gas 7 undergoes a relevant cooling 71 in purification gas 1: temperature may change from 1600° C. at the origin of torch 26 to about of 1400° C. at outlet port 14. Cooling 71 is assisted by gas expansion, which takes place due to divergent shape of portion 21.

FIG. 7 shows an apparatus 500 according to a further exemplary embodiment of the invention, in which purification chamber 1 contains two further electrodes 46 downstream of electrodes 16 according to flow direction; Electrodes 16 are each connected to a voltage applying means 19 that applies a further voltage V′ between them, which creates an electric field E′, not shown, suitable for keeping gas 6/7 in the state of a plasma, and for triggering a further torch flow 56 or for further extending torch 26. This way efficiency of purification chamber 1 is significantly increased. The further, or even more further pair of electrodes may be used also in an equipment in which electrodes 16 and offgas inlet port 11 are arranged as shown in FIG. 5.

Progressively diverging portion 21 of purification chamber 1 (FIG. 2) communicates with the inlet part 29 of a tube-bundle heat exchanger 2. Inlet part 29 is strongly diverging according to the flow of purified gas 7, which therefore is further expanded; such expansion promotes a further cooling 72 up to about of 100° C., as shows FIG. 6.

Exchanger 2 comprises a cylindrical shell 32 and a tube-bundle 33 which can comprise, as in the example of FIG. 4, five straight tubes 34 for internal passage of purified gas 7. Tubes 34 are arranged according to the direction of shell 32; a central distributing duct 35, co-axially arranged inside shell 32, is connected to a cooling fluid supplying means, not shown, for example a water pump. Tubes 34 and distributing duct 35 are fastened to tube-sheets 37, which are in turn connected to shell 32 for example by means of circumferential welding, as shown in FIG. 2. Distributing duct 35 has opening, not shown, to allow a cooling liquid to flow into a recess 38 outside tubes 34. To enhance heat exchange by water spraying, spraying nozzles can be provided at the openings. Cooling liquid 40, by contacting the external, hot surface of tubes 34 is partially changed into steam 44 that flows away of exchanger 2 through an opening 41 and a duct 42 through which it can be sent to a conventional means to recover thermal energy. The cooling liquid 45 which is not vaporized inside exchanger 2 is withdrawn from exchanger 2 by a lower opening 49 of shell 32 and a drainage duct 43.

As shown in FIGS. 3 and 4, tubes 34 of exchanger 2 provide an overall gas passage whose area is at least five times the passage area of port 14 of outlet diverging portion 21 of purification chamber 1. This permits to take into account the quick expansion of gas 7 while flowing through inlet zone 29 between purification chamber 1 and exchanger 2, where purified gas 7 undergoes a cooling 73 down to about 400° C., which is the temperature of resulting cooled gas 8.

A scrubber 3 for washing cooled gas 8 is arranged downstream exchanger 2. Washing is carried out by a washing water 54 that is supplied by a water supplying network 51 to one or more distributing water ducts 52, that are arranged along a generatrix of preferably cylindrical scrubbing chamber 59 of scrubber 3. Washing water 54 is preferably sprayed into scrubbing chamber 59 through spraying nozzles 53, which create a stationary mist inside scrubbing chamber 59.

While flowing through scrubbing chamber 59 of scrubber 3, cooled gas 8 undergoes a further cooling 74 (FIG. 6), down to a temperature below an admissible limit for atmospheric gas emissions, which is normally set between 80 and 150° C. This is the temperature of washed gas 9 resulting from further cooling 74. Downstream of scrubber 3 a deflector or a demister 57 is provided to remove water droplets from washed gas 9 a collecting and draining means 58 is also provided downstream of deflector or demister 57 to collect and drain water removed from washed gas 9.

Finally, a blower 4 is provided for providing a vacuum degree inside apparatus 300, such that offgas 6, purified gas 7, cooled gas 8 and washed gas 9 flows throughout apparatus 300 and is finally expulsed into atmosphere 70 through outlet holes 66 of diffuser 5.

With reference to FIG. 8, a tube-bundle heat exchanger 80 is described according to an exemplary embodiment alternative to exchanger 2 of FIG. 2. In heat exchanger 80, purified gas 7 is directed upwards. Exchanger 80 has an inlet part 75 that is strongly diverging according to the direction of purified gas 7. Inlet part 75 is defined by a shell, for example a frusto-conic shell 76′. Such a shape allows quick expansion and therefore quick cooling of purified gas 7. Exchanger 80 comprises, furthermore, a cylindrical shell 76 and a tube-bundle 91 that comprises of a plurality of tubes 77, partially shown, through which purified gas 7 flows. A central distributing duct 78, which is co-axial to shell 76′, is connected through a duct 79 to a cooling liquid 95 supplying means (not shown), in particular, a water supplying means. Tubes 77 and distributing duct 78 are fixed to through holes 96 of two tube-sheets 81, one of which is shown in FIG. 8, that are connected to cylindrical shell 76.

Along the generatrices of distributing duct 78, openings are provided (not shown) to release cooling liquid 95 into a recess 82 outside tubes 77 of the exchanger 80 and defined by cylindrical shell 76. Such openings can be equipped with spraying nozzles for spraying cooling liquid 95, to assist heat exchange. Cooling liquid 95 contacts the external surface of hot tubes 77 and is therefore partially changed into vapour 97, in particular, steam; vapour 97 is drawn through a vapour outlet port 83 and flows through duct 84 to conventional energy recovery means, not shown. The amount of cooling liquid 95 which do not vaporize is withdrawn from recess 82 through a draining pipe 86 fitted with a lower opening 85 of cylindrical shell 76. Finally, exchanger 80 comprises a cooled gas outlet part 88, that can be symmetrical to purified gas inlet part 75, and is defined by frusto-conic shell 76″. In frusto-conic shell 76″ a cone 89 is provided which to remove residual solid particles (not shown) from cooled gas 8. The particles hit against the wall of outlet part 88 and fall back by gravity.

FIG. 9 is a transverse section view of an apparatus 600, according to an another exemplary embodiment of the invention, for purifying an offgas 6. Apparatus 600 comprises five serial arranged portions that longitudinally extend along a common axis 10:

a purification chamber 1, which has a plurality of inlet ports 67 and corresponding electrodes to create respective plasma torches, which is useful to treat high amounts of offgas;

a tube-bundle exchanger 2;

a scrubber 3;

a fan or a blower 4;

a diffuser 5 with gas outlet holes 66.

Purification chamber 1 is slightly diverging, as purification chamber 1 of FIGS. 1 and 7, although the opening angle α is not represented for clearness' sake.

In particular, scrubber 3 has a scrubbing chamber 93′ in which a network of coils 93″ is arranged; holes (not shown) are provded through coils 93′ for spraying washing water and into chamber 93′, and create an uniform mist inside it.

The foregoing description of specific embodiments will so fully reveal the invention according to the conceptual point of view, so that others, by applying current knowledge, will be able to modify and/or adapt for various applications such embodiments without further research and without parting from the invention, and it is therefore to be understood that such adaptations and modifications will have to be considered as equivalent to the specific embodiments. The means and the materials to realise the different functions described herein could have a different nature without, for this reason, departing from the field of the invention. It is to be understood that the phraseology or terminology employed herein is for the purpose of description and not of limitation.

1. A method for purifying an offgas (6) comprising the steps of:
prearranging a purification chamber (1), said chamber having an inlet port (13) and an outlet port (14);
arranging a pair of electrodes (16) in said purification chamber (1);
applying a voltage (V) to said electrodes (16) such that an electric field of prefixed intensity (E) is established between said electrodes (16);
feeding said offgas (6) into said purification chamber (1) through said inlet port (13);
in said purification chamber (1) turning said offgas (6) into a ionized gas (26), i.e. a plasma, and
causing said ionized gas to separate into heavier molecules, which fall as a substantially liquid residue, i.e. a lava (23), and lighter molecules which form a purified gas (7);
collecting said purified gas (7) from said purification chamber (1) through said outlet port (14);
collecting said substantially liquid residue (23) from said purification chamber (1),
characterized in that said step of turning said offgas (6) into a ionized gas (26) is obtained by causing in said purification chamber an electrical discharge to pass between said electrodes (16) through said offgas (6).

2. A method according to claim 1, wherein said step of causing said ionized gas to separate is achieved by causing said ionized gas (26) to expand while flowing through said purification chamber (1) towards said outlet port (14).

3. A method according to claim 2, wherein said purification chamber (1) has a cross section and said expansion is caused by a progressive increase of said purification chamber (1) cross section towards said outlet port (14).

4. A method according to claim 3, wherein a further expansion of said purified gas (7) is caused by an inlet portion (29) of a cooling part of a heat exchanger (2), in particular said cooling part has an enlarged cross sectional area (T) set between three times and seven times said outlet port (14), in particular said enlarged cross sectional area (T) about five times a restricted cross sectional area (S) of said outlet port (14).

5. A method according to claim 1, wherein said offgas (6) hits an internal surface (28) of said purification chamber (1) proximate to said electrodes (16), such that said offgas (6) enters said purification chamber (1) according to an inlet direction (12) and undergoes a sudden change according to a predetermined diverted direction, in particular, said diverted direction is transversal to said inlet direction (12).

6. A method according to claim 1, wherein said pair of electrodes (16) is a first pair of electrodes, and further steps are provided of:
arranging a further pair of electrodes (46) in said purification chamber (1) downstream of said first pair of electrodes (16) according to said gas flow (26);
applying a further voltage (V′) to said further electrodes (46) such that a further electric field of prefixed intensity (E′) is established between said further electrodes (46) for maintaining said plasma flow (26);
in particular, said further pair of electrodes (46) is arranged at an angle with respect to said first pair of electrodes (16).

7. A method according to claim 1, wherein said pair of electrodes (16) transfers by said discharge to said offgas (6) an energy comprised between 0.5-1 KWh for each kg of impurities of said offgas (6), preferably said energy comprised between 0.7-0.9 KWh/kg of impurities.

8. An apparatus (300, 400, 500, 600) for purifying an offgas (6), said apparatus comprising:
a purification chamber (1), said chamber having an inlet port (13) and an outlet port (14), said inlet port (13) and said outlet port (14) having respective prefixed cross sectional areas (R,S);
a pair of electrodes (16) that are located inside said purification chamber (1);
a voltage applying means (19) for applying to said electrodes (16) a voltage (V) such that an electric field of prefixed intensity (E) is established between said electrodes (16);
an offgas feeding means for feeding said offgas (6) into said purification chamber (1) through said inlet port (13);
a means for turning said offgas (6) into a ionized gas (26) in said purification chamber (1), i.e. a plasma,
a means for causing said ionized gas to separate into heavier molecules, which fall as a substantially liquid residue, i.e. a lava (23), and lighter molecules which form a purified gas (7);
a gas collecting means for collecting said gas from said purification chamber (1);
a lava collecting/extracting means (22) for collecting and extracting said lava (23) from said purification chamber (1),
characterized in that said means for turning said offgas (6) into a ionized gas (26) are adapted to cause an electrical discharge to pass through said offgas (6) between said electrodes (16).

9. An apparatus according to claim 8, wherein said purification chamber (1) has a progressively diverging portion (21), in particular said progressively diverging portion (21) is located immediately downstream of said electrodes, said progressively diverging portion (21) adapted to promote an expansion of said plasma that flows towards said outlet port (14).

10. An apparatus (300, 400, 500, 600) according to claim 8, wherein said progressively diverging portion is a frusto-conical portion (21), in particular said frusto-conical portion (21) has an opening angle (α) set between two degrees and six degrees, more in particular said opening angle (α) is about four degrees.

11. An apparatus (500,600) according to claim 8, wherein said pair of electrodes (16) is a first pair of electrodes (16), and said purification chamber (1) comprises:
a further pair of further electrodes (46);
a further voltage applying means (48) for applying a further voltage (V′) to said further electrodes (46) such that a further electric field (E′) is established suitable for maintaining said plasma flow (26-56).

12. An apparatus (300) according to claim 8, wherein a heat exchanger (2,80) with a cooling part (33,91) is arranged downstream said outlet port (14) of said purification chamber (1), in particular said heat exchanger (2,80) has a cross sectional area that increases according to the flow of said purified gas (7), such that said purified gas (7) further expands before or inside said cooling part (33,91).

13. An apparatus (300) according to claim 12, wherein said heat exchanger (2,80) comprises a divergent inlet part (29,75) upstream of said cooling part (33,91), and said cooling part (33,91) has an enlarged cross sectional area (T) that ranges from three times to seven times said outlet port (14) of said purification chamber (1), preferably said enlarged cross sectional area (T) of said cooling part is about five times a restricted sectional area (S) of said outlet port (14) of said purification chamber (1).

14. An apparatus (300) according to claim 8, wherein said heat exchanger (2,80) includes:
a bundle (33) of tubes (34,77), said tube-bundle (33,91) adapted to let said purified gas (7) to flow and be cooled within said tubes (34,77);
a distributing duct (35,78), said distributing duct having holes for spraying a cooling liquid (40,95) on an external surface of said tubes (34,77).

15. An apparatus (600) according to claim 8, wherein a scrubber (3) is arranged downstream of said purification chamber, said scrubber (3) having a scrubbing chamber (93′) and a plurality of coils (93″) arranged therein, in particular substantially helix-shaped coils (93″), said plurality preferably comprising a network of coils, said coils having holes spraying or nebulising a scrubbing water uniformly distributed in said scrubbing chamber (93′).
